(19) United States
(12) Patent Application Publication
(10) Pub. No.: US 2023/0203930 A1
(43) Pub. Date: Jun. 29, 2023

(54) COMPOSITIONS AND METHODS FOR IMPROVED RESERVOIR FLUIDS SEPARATION

(71) Applicant: Solugen, Inc., Houston, TX (US)

(72) Inventors: Thomas A. Swanson, Houston, TX (US); David Laperouse, Houston, TX (US); Jun Su An, Houston, TX (US); Paul Schuber, Sugar Land, TX (US)

(73) Assignee: Solugen, Inc., Houston, TX (US)

(21) Appl. No.: 17/926,569

(22) PCT Filed: Jun. 14, 2021
(86) PCT No.: PCT/US2021/037268

§ 371 Date: Nov. 18, 2022

Related U.S. Application Data
(60) Provisional application No. 63/038,946, filed on Jun. 15, 2020.

(51) Int. Cl. E21B 43/38; B01D 17/04

(52) U.S. Cl. CPC E21B 43/38; B01D 17/047

(57) ABSTRACT

A method of treating a reservoir fluid mixture including an oleaginous component and an aqueous component includes contacting the reservoir fluid mixture with an interface destabilizing composition. The interface destabilizing composition comprises a biochelant and a solvent. A method of servicing a wellbore includes flowing a reservoir fluid to a vessel. The reservoir fluid comprises an oleaginous component and an aqueous component. The method also includes introducing into the vessel an interface destabilizing composition comprising a biochelant and a solvent. The vessel comprises a gun barrel or wash tank separator. In addition, the method includes recovering at least a portion of the oleaginous component from the vessel.

### CROSS-REFERENCE TO RELATED APPLICATIONS

This application is a 35 U.S.C. § 371 national stage application of PCT/US2021/037268 filed Jun. 14, 2021, and entitled “Compositions and Methods for Improved Reservoir Fluids Separation,” which claims the benefit of U.S. provisional patent application Ser. No. 63/038,946 filed Jun. 15, 2020, and entitled “Compositions and Methods for Improved Reservoir Fluids Separation,” each of which is hereby incorporated herein by reference in its entirety for all purposes.

### STATEMENT REGARDING FEDERALLY SPONSORED RESEARCH OR DEVELOPMENT

Not applicable.

### FIELD

The present disclosure relates generally to compositions and methods for fluid separation. More particularly, the present disclosure relates to compositions and methods for the improved separation of fluids produced from a hydrocarbon-containing reservoir.

### BACKGROUND

Reservoir fluids produced at a wellhead can be comprised of a complex mixture of liquids, gases, and solids. An oil well often produces small amounts of natural gas, along with salt water, while natural gas wells often produce salt water and liquid hydrocarbons. In addition, oil and gas wells can produce solids including sand, scale, and shale sediments.

Produced reservoir fluids flowing out of the wellhead pass into and through an attached pipe referred to as a flowline. The fluids pass through the flowline into a hollow steel vessel referred to as a separator.

There are two-phase and three-phase separators. The type of separator used depends on the characteristics of the water produced from the well. A two-phase separator uses the force of gravity to divide the reservoir fluids into liquids and gas. In this case, minute droplets of produced water are uniformly distributed within the oil and closely bound to the oil. Oil and water in this state is an emulsion. The emulsion, which is relatively heavy, is driven out the bottom of the separator. Gas, which is relatively light (i.e., lighter than the emulsion), goes out the top of the separator.

A three-phase separator is used when some of the produced water rapidly settles out of the oil. This type of water is referred to as free water. In the three-phase separator, free water will go out the bottom of the separator. Oil, or an emulsion if the oil also contains water droplets, goes out the middle of the separator, while gas still goes out the top.

### SUMMARY

Disclosed herein is a method of treating a reservoir fluid mixture comprising an oleaginous component and an aqueous component, the method comprising contacting the reservoir fluid mixture with an interface destabilizing composition, wherein the interface destabilizing composition comprises a biochelant and a solvent.

Also disclosed herein is a method of servicing a wellbore, the method comprising flowing a reservoir fluid to a vessel, wherein the reservoir fluid comprises an oleaginous component and an aqueous component; introducing into the vessel an interface destabilizing composition comprising a biochelant and a solvent, wherein the vessel comprises a gun barrel or wash tank separator; and recovering at least a portion of the oleaginous component from the vessel.

### BRIEF DESCRIPTION OF THE DRAWINGS

For a detailed description of the aspects of the presently disclosed subject matter, reference will now be made to the accompanying drawings in which:

FIGS. 1 and 2 are schematic views of embodiments of systems for fluid separation using an IDC of the type disclosed herein.

FIG. 3 is a schematic view of an embodiment of a salt water disposal and water injection system that can be used with an IDC of the type disclosed herein.

FIG. 4 is a graph illustrating the amount of basic sediment and water (BS&W) as a function of time for the samples from Example 1.

### DETAILED DESCRIPTION

The efficiencies of the separation process directly impact the produced fluid volume. As most hydrocarbon-containing reservoirs produce all three phases (water, oil, and gas), proper separation yields a direct increase in revenue. For example, if a 100 barrel (bbl.) of produced reservoir fluids contains 10% oil and 90% water, the perfect separation will yield 10 bbl. of oil and 90 bbl. of water. However, this is rarely the case. In many instances, the volume of the separated “oil” phase is below about 8 bbl., in other words a yield of less than about 80%, and the volume of separated water is above 90 bbl. This is not due to the fact that more water has been created; this is merely due to the fact the separation process is far from perfect. For example, the water phase will often contain small volumes of oil trapped in an emulsion. Consequently, in many instances, a surfactant is employed as a component of a demulsifier package to break any emulsion that occurs in the separator and increase the efficiency of the separator.

The challenge of efficient separation of reservoir fluids is further complicated by the presence of precipitants that can collect and foul the inside of the separator, thereby decreasing the efficiency separation. These precipitants include, but are not limited to iron sulfide, inorganic scale, formation fines, and produced sand/proppant. All of these precipitants interact with the oil and water interface in the separator. As many of these precipitants become oil-wet, the use of demulsifying surfactants may be increased to combat the problem. However, by addressing the core issue (i.e., precipitant removal, dispersion, and chelation), chemical volumes and usage can be decreased while increasing separator efficiency, and thereby the volume of hydrocarbon produced.

Thus, an ongoing need exists for compositions and methods that improve the efficiency of separation of reservoir fluids.

Disclosed herein are compositions and methods for the efficient separation of fluids obtained from hydrocarbon-containing (e.g., oil and gas) reservoirs. Oil and gas reservoirs are porous and permeable formations that contain interconnected passageways of microscopic pores or holes that occupy the areas between the mineral grains of the rock. When oil and gas have been naturally expelled from source rocks, they enter or migrate into the adjacent reservoir rocks. Most oil and gas reservoir rocks are sandstones, limestones, or dolomites.

In an aspect, the compositions of the present disclosure comprise a chelant that functions to destabilize the fluid interfaces formed when differing reservoir fluids intermingle or mix, and facilitate the separation of mixed reservoir fluids. Herein, these compositions are termed interface destabilizing compositions (IDCs). In an aspect, the compositions of the IDCs of the present disclosure are comprised of a chelant and solvent. Methods of introducing these compositions to reservoir fluids and facilitating the efficient separation of these fluids are described in more detail later herein.

In an aspect, the IDC comprises a chelant (also known as a chelating agent), alternatively a biochelant. Herein, a chelant, also termed a sequestrant or a chelating agent, refers to a molecule capable of bonding a metal. The chelating agent is a ligand that contains two or more electron-donating groups so that more than one bond is formed between each of the atoms on the ligand to the metal. This bond can also be dative or a coordinating covalent bond meaning the electrons from each electronegative atom provides both electrons to form the bond to the metal center. Additionally, a chelant suitable for use in the present disclosure comprises a material capable of effectively chelating to a metal cation in any oxidation state. For example, the chelant may bind to a metal in the monovalent, divalent or, trivalent oxidation state. The chelant may also bind the metal cation in higher oxidation states (e.g., up to 10).

In an aspect, the chelant is a biochelant. As used herein, the prefix “bio” indicates that the chemical is produced by a biological process such as using an enzyme catalyst.

In an aspect, the biochelant comprises aldonic acid, uronic acid, aldaric acid, or a combination thereof; and a counter cation. The counter cation may comprise an alkali metal (Group I), an alkali earth metal (Group II), a transition metal, or a combination thereof. In certain aspects, the counter cation is sodium, potassium, magnesium, calcium, strontium, cesium, copper, iron, palladium, manganese, or a combination thereof.

In an aspect, the biochelant comprises a glucose oxidation product, a gluconic acid oxidation product, a gluconate, or a combination thereof. The glucose oxidation product, gluconic acid oxidation product, gluconate or the combination thereof may be buffered to a suitable pH. Buffering can be carried out using any suitable methodology such as by using a pH adjusting material in an amount of from about 1 weight percent (wt. %) to about 10 wt. %, alternatively from about 1 wt. % to about 3 wt. %, or alternatively from about 5 wt. % to about 9 wt. % based on the total weight of the biochelant. In an aspect, the biochelant comprises from about 1 wt. % to about 8 wt. % of a caustic solution in a 20 wt. % gluconate solution. Herein, all weight percentages are based on the total weight of the composition (e.g., IDC) unless specified otherwise.

Alternatively, the biochelant comprises a buffered glucose oxidation product, a buffered gluconic acid oxidation product, or a combination thereof. In such aspects, the buffered glucose oxidation product, the buffered gluconic acid oxidation product, or the combination thereof is buffered to a suitable pH (e.g., 6-7) using any suitable acid or base such as sodium hydroxide. In such aspects, the biochelant comprises a mixture of gluconic acid and glucaric acid, and further comprises a minor component species comprising n-keto-acids, C₂-C₆ diacids, or a combination thereof. In an aspect, the biochelant comprises BIOCHELATE™ metal chelation product commercially available from Solugen Inc. of Houston, Tex.

In an aspect, the IDC comprises from about 0.01 to about 100 weight percent (wt. %), alternatively from about 0.5 wt. % to about 60 wt. % of the primary chelant (as 60 wt. % is the approximate maximum concentration in an aqueous phase), alternatively from about 0.01 to about 30 wt. % (maximum concentration of the neutralized salt in the aqueous phase), or alternatively from about 1 wt. % to about 100 wt. % (salted form is a solid) based on the total weight of the IDC and solubility, water chemistry (cation concentration, pH).

In an aspect, the IDC further comprises a solvent. A solvent suitable for use in the present disclosure is an aqueous fluid such as water, an aromatic hydrocarbon such as xylene, or both. In some aspects, the IDC may be winterized with the use of an alcohol as a solvent such as methanol, ethanol, isopropanol, ethylene glycol, propylene glycol, or combination thereof. In an aspect, the IDC comprises solvent in an amount of from about 10 wt. % to about 90 wt. %, alternatively from about 20 wt. % to about 45 wt. %, or alternatively from about 30 wt. % to about 40 wt. %. In an aspect, the solvent comprises the remainder of the IDC when all other components are accounted for.

In an aspect, the fluids are reservoir fluids such as obtained during wellbore servicing operations and the compositions disclosed herein may function in various ways to destabilize an interface formed between intermingled reservoir fluids. Reservoir fluids refer to the fluid mixture (e.g., water, oil, gas, or combinations thereof) contained within a resource-bearing reservoir. Reservoir fluids normally include liquid hydrocarbon (mainly crude oil), aqueous fluids, aqueous solutions with dissolved salt, and hydrocarbon and non-hydrocarbon gases such as methane and hydrogen sulfide. In some aspects, the intermingling of reservoir fluids results in an emulsion and the IDC functions in a manner similar to a demulsifier.

In one or more aspects, an IDC of the type disclosed herein functions to disperse and chelate precipitants such as iron sulfide, and destabilize an oil/water interface formed by the intermingling or mixing of fluids from hydrocarbon-containing reservoirs. In one or more aspects, the separation of reservoir fluids using an IDC of the type disclosed herein excludes the use of a surfactant or demulsifier.

One or more additives may be included in an IDC of the type disclosed herein to meet some user and/or process goal provided such additives are compatible with the other components of the IDC. Examples of such additives include, but are not limited to a strength-stabilizing agent, a friction reducer, an expansion agent, a salt, a fluid loss agent, a vitrified shale, a thixotropic agent, a dispersing agent, a surfactant, a scale inhibitor, a clay stabilizer, a silicate-control agent, a biocide, a biostatic agent, a storage stabilizer, a filtration control additive, acids, bases, mutual solvents, accelerants, corrosion inhibitor, defoamer oxidation inhibitors, thinners, scavengers, gas scavengers, or a combination thereof. Additives may be included singularly or in combinations in amounts effective to meet some user and/or application goal.

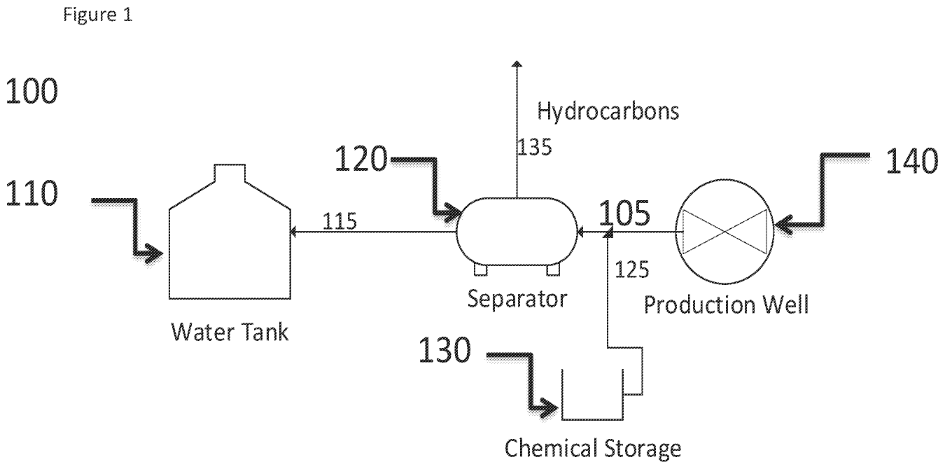

An IDC of the present disclosure may be introduced to any mixture of fluids that when contacted form an interface. The IDC may function to destabilize the interface and facilitate separation of the fluids. In an aspect, fluid separation utilizing an IDC may be carried out in a system of the type depicted in FIG. 1. Referring to FIG. 1, a system for fluid separation 100 comprises a production well 140 that is disposed upstream of a separator 120. Although FIG. 1 depicts a single separator 120, one or more separators may be utilized. The separator 120 may be an oil/gas separator that is a pressure vessel used for separating a well stream into gaseous and liquid components. Based on the vessel configurations, the oil/gas separators can be divided into horizontal, vertical, or spherical separators. In terms of fluids to be separated, the oil/gas separators can be grouped into gas/liquid two-phase separators or oil/gas/water three-phase separators.

Based on separation function, the oil/gas separators can also be classified into primary phase separator, test separator, high-pressure separator, low-pressure separator, coalescer, or degasser. To meet process requirements, the oil/gas separators are normally designed in stages, in which the first stage separator is used for preliminary phase separation, while the second and third stage separators are applied for further treatment of each individual phase (gas, oil and water). Depending on a specific application, oil/gas separators may also be referred to as a coalescers or a degasser. In general, coalescers are used to remove dispersed droplets from a bulk gas stream, while degassers are designed to remove contaminated gas.

The separator 120 is in fluid communication with the production well 140 via a flowline 105. The separator 120 may also be in fluid communication with an upstream water tank 110 via a flowline 115. In an aspect, reservoir fluids from the production well 140 are conveyed via flowline 105 to the separator 120. In such an aspect, the IDC may be stored in chemical storage 130 and introduced to the reservoir fluids flowing from the production well 140 to the separator 120 via flowline 125. After treatment in the separator 120, separated hydrocarbons are conveyed from the separator 120 via a flowline 135 while water exiting the separator 120 is conveyed to the water tank 110 via the flowline 115.

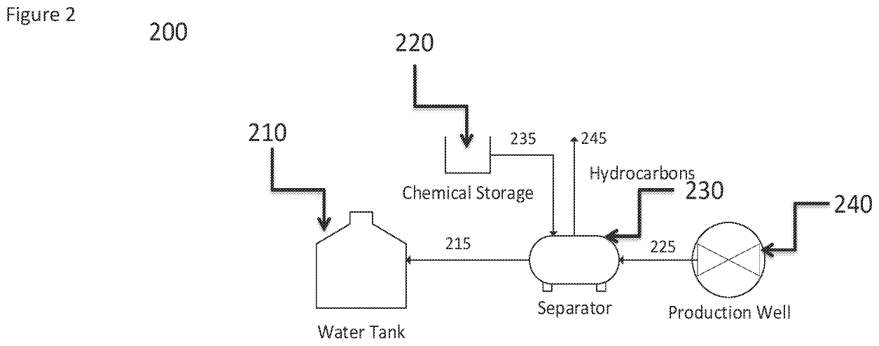

In another aspect, fluid separation utilizing an IDC may be carried out in a system of the type depicted in FIG. 2. Referring to FIG. 2, a system 200 for fluid separation comprises a production well 240 that is disposed upstream of a separator 230. The separator 230 is in fluid communication with the production well 240 via a flowline 225. The separator 230 may also be in fluid communication with an upstream water tank 210 via a flowline 215.

In an aspect, reservoir fluids from the production well 240 are conveyed via the flowline 225 to the separator 230. Although FIG. 2 depicts a single separator, one or more separators may be utilized. In such an aspect, the IDC may be stored in chemical storage 220 and introduced directly to the reservoir fluids located in separator 230 via the flowline 235. After treatment in the separator 230, separated hydrocarbons are conveyed from the separator via the flowline 245 while water exiting the separator is conveyed to the water tank 210 via the flowline 215.

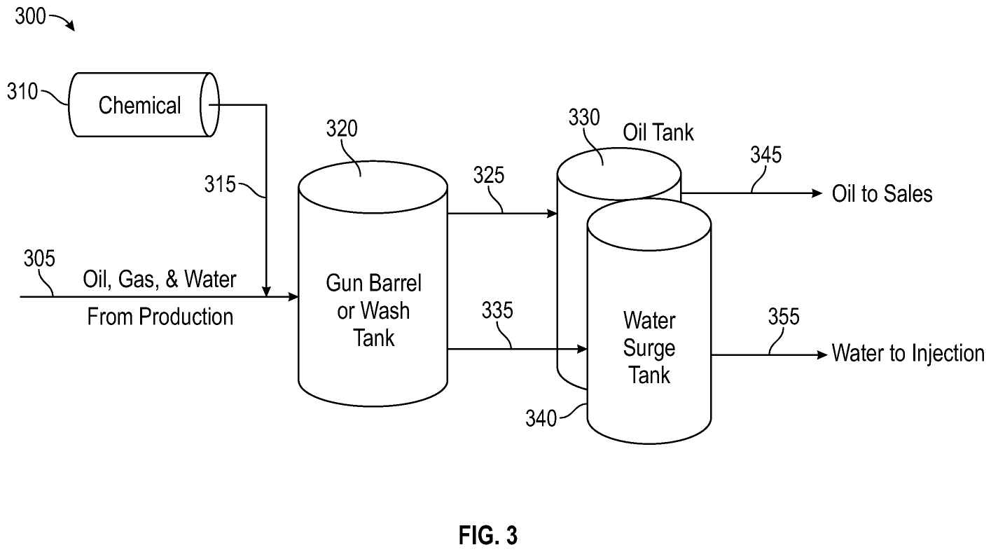

In an aspect, reservoir fluids separation can be a component of a salt water disposal and water injection system as depicted in FIG. 3. Referring to FIG. 3, the IDC may be introduced from a container or vessel 310 via a flowline 315 to a flowline that conveys reservoir fluids 305 (e.g., a mixture of oil, gas, water, or a combination thereof) to a gun barrel or wash tank 320. Separation of the reservoir fluids 305 is carried out in the gun barrel or wash tank 320. The separation products oil and water exit the gun barrel or wash tank via flowline 325 and 335, respectively. In an aspect, separated oil is conveyed to an oil storage tank 330 from the gun barrel or wash tank 320 via the flowline 325. In an aspect, separated water is conveyed to a water storage tank 340 from the gun barrel or wash tank 320 via the flowline 335. Further processing of the separated oil and water may be carried out using any suitable equipment and methodology situated downstream of the flowlines 345 and 355, respectively.

Aspects of the compositions and methods disclosed herein have been described. In some aspects, the IDC functions as a treatment fluid that facilitates separation of reservoir fluids that have mixed or intermingled. In various aspects, the treatment fluids disclosed herein (i.e., IDCs) are utilized to (i) treat oil/water emulsions and interfaces fluid at an oil and gas facility such as a producing well; its downstream processing facilities or a network of surface production equipment; (ii) used as a treatment fluid in a water injection facility to reclaim crude oil at a specific quality; and (iii) used at a water disposal facility to reclaim crude oil at a specific quality.

In an aspect, a method of the present disclosure comprises contacting an IDC with a fluid mixture, wherein the fluid mixture comprises at least an aqueous fluid and an oleaginous fluid. Contacting of the IDF with the fluid mixture may be carried out in any suitable vessel or container for any period of time sufficient to separate the mixture into one or more phases.

The IDCs of this disclosure provide compositions for reducing the oil/water interface “pad” formed by the intermingling or mixing of reservoir fluids. A reduction in the stability of the interface may translate into an increased efficiency of separation. For example, utilizing an IDC of the type disclosed herein may result in the recovery of equal to or greater than about 80% of a hydrocarbon resource obtained as a mixture of fluids from a reservoir. Alternatively, the resource recovery may be increased by from about 20% to about 40% or alternatively from about 40% to about 80% when compared to a separation carried out in the absence of an IDC.

Use of an IDC of the type disclosed herein also results in the formation of less precipitants such as basic sediment and water (BS&W), thereby providing economic benefits such as decreased processing cost. For example, a mixture of fluids obtained from a reservoir and comprising a resource when contacted with an IDC may have precipitant formation reduced by from about 0.2% to about 5%, alternatively from about 0.5% to about 5% or alternatively from about 1% to about 5% when compared to a separation process lacking an IDC of the type disclosed herein. Further advantages of the present disclosure include the ability to reduce or eliminate the use of demulsifers and/or surfactants in the separation of reservoir fluids. In some embodiments, a method of separating reservoir fluid comprising an IDC excludes the use of a surfactant. In some embodiments, a method of separating reservoir fluid comprising an IDC excludes the use of a demulsifier.

IDCs of the type disclosed herein advantageously address the core problem in the separation of reservoir fluids, the formation of a stable oil/water interface facilitated by the formation of oil-wet precipitants (e.g., iron sulfide). Additionally, removal of the interface also removes unwanted species in the oil (water, solids, and other precipitants (e.g. BS&W), increasing the value of the oil, and decreasing the downstream processing of the oil.

### EXAMPLES

The presently disclosed subject matter having been generally described, the following examples are given as particular aspects of the subject matter and to demonstrate the practice and advantages thereof. It is understood that the examples are given by way of illustration and are not intended to limit the specification or the claims in any manner.

### Example 1

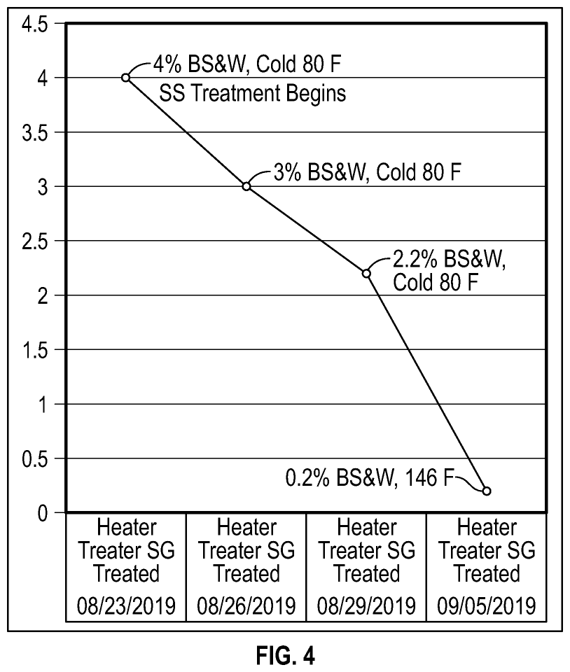

The ability of an IDC of the present disclosure to facilitate reservoir fluid separation was investigated. The experiment involved injecting an IDC into a producing well facility. The efficacy of the fluid separation was determined by monitoring the amount of basic sediment and water (BS&W) a function of time. The results are presented in FIG. 4. As shown in FIG. 4 at equal temperatures, the addition of an IDC of the type disclosed herein resulted in a 45% reduction in BS&W.

### Example 2

A solution of produced water and oil from a producing well was dosed with different materials used to facilitate the separation of reservoir fluids. An IDC of the type disclosed herein did not produce any emulsions and was observed to produce a clear separation of the oil/water interface.

### Additional Disclosure

The following are non-limiting, specific embodiments in accordance with the present disclosure:

A first aspect which is a method of treating a reservoir fluid mixture comprising an oleaginous component and an aqueous component, the method comprising:

contacting the reservoir fluid mixture with an interface destabilizing composition, wherein the interface destabilizing composition comprises a biochelant and a solvent.

A second aspect which is the method of the first aspect, wherein the biochelant comprises uronic acid, aldaric acid, a salt thereof, a derivative thereof, or a combination thereof.

A third aspect which is the method of any of the first through second aspects wherein the biochelant comprises sodium gluconate, a glucarate, an oxidation product of sodium glucarate, gluconate, a derivative thereof, or a combination thereof.

A fourth aspect which is the method of any of the first through third aspects wherein the biochelant comprises a buffered glucose oxidation product, a buffered gluconic acid oxidation product, or a combination thereof.

A fifth aspect which is the method of the fourth aspect wherein the buffered glucose oxidation product, the buffered gluconic acid oxidation product, or the combination thereof further comprises n-keto-acids, C₂-C₆ diacids, or a combination thereof.

A sixth aspect which is the method of any of the first through fifth aspects wherein the biochelant is present in the interface destabilizing composition in an amount of from about 0.01 wt. % to about 100 wt. % based on the total weight of the interface destabilizing composition.

A seventh aspect which is the method of any of the first through sixth aspects, wherein the solvent comprises an aqueous fluid, an aromatic hydrocarbon, or both.

An eighth aspect which is the method of the seventh aspect wherein the solvent comprises an alcohol.

A ninth aspect which is the method of the eighth aspect wherein the alcohol comprises methanol, ethanol, isopropanol, ethylene glycol, propylene glycol, or a combination thereof.

A tenth aspect which is the method of any of the first through ninth aspects wherein the reservoir fluid comprises a liquid hydrocarbon, an aqueous fluid, an aqueous solution with a dissolved salt, a hydrocarbon gas, a non-hydrocarbon gas, or a combination thereof.

An eleventh aspect which is the method of any of the first through tenth aspects wherein the interface destabilizing composition comprises an additive selected from the group consisting of a strength-stabilizing agent, a friction reducer, an expansion agent, a salt, a fluid loss agent, a vitrified shale, a thixotropic agent, a dispersing agent, a surfactant, a scale inhibitor, a clay stabilizer, a silicate-control agent, a biocide, a biostatic agent, a storage stabilizer, a filtration control additive, an acid, a base, mutual solvents, an accelerant, a corrosion inhibitor, a defoamer oxidation inhibitor, a thinner, a scavenger, a gas scavenger, or a combination thereof.

A twelfth aspect which is the method of any of the first through eleventh aspects further comprising recovering the oleaginous component of the reservoir fluid mixture.

A thirteenth aspect which is the method of the twelfth aspect wherein the recovery is equal to or greater than about 80%.

A fourteenth aspect which is the method of any of the first through thirteenth aspects wherein a precipitant formed is reduced by from about 0.2% to less than about 5% when compared to a separation process lacking an interface destabilizing composition.

A fifteenth aspect which is the method of any of the first through fourteenth aspects wherein the interface destabilizing composition excludes a surfactant.

A sixteenth aspect which is the method of any of the first through fifteenth aspects wherein the interface destabilizing composition excludes a demulsifier.

A seventeenth aspect which is the method of any of the first through sixteenth aspects wherein the reservoir fluid mixture comprises an oil-in-water emulsion.

An eighteenth aspect, which is the method of any of the first through seventeenth aspects wherein the interface destabilizing composition is introduced to a separator containing at least a portion of the reservoir fluid.

A nineteenth aspect which is the method of any of the first through eighteenth aspects wherein the interface destabilizing composition is introduced into a conduit conveying the reservoir fluid from a production well to a separator.

A twentieth aspect which is the method of any of the first through nineteenth aspects wherein the interface destabilizing composition is introduced into a gun barrel or wash tank separator.

A twenty-first aspect which is a method of servicing a wellbore, the method comprising flowing a reservoir fluid to a vessel, wherein the reservoir fluid comprises an oleaginous component and an aqueous component; introducing into the vessel an interface destabilizing composition comprising a biochelant and a solvent, wherein the vessel comprises a gun barrel or wash tank separator; and recovering at least a portion of the oleaginous component from the vessel.

While aspects of the presently disclosed subject matter have been shown and described, modifications thereof can be made by one skilled in the art without departing from the spirit and teachings of the subject matter. The aspects described herein are exemplary only and are not intended to be limiting. Many variations and modifications of the subject matter disclosed herein are possible and are within the scope of the disclosed subject matter. Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.). Use of the term “optionally” with respect to any element of a claim is intended to mean that the subject element is required, or alternatively, is not required. Both alternatives are intended to be within the scope of the claim. Use of broader terms such as comprises, includes, having, etc. should be understood to provide support for narrower terms such as consisting of, consisting essentially of, comprised substantially of, etc.

Accordingly, the scope of protection is not limited by the description set out above but is only limited by the claims which follow, that scope including all equivalents of the subject matter of the claims. Each and every claim is incorporated into the specification as an aspect of the present disclosure. Thus, the claims are a further description and are an addition to the aspects of the present invention. The discussion of a reference herein is not an admission that it is prior art to the presently disclosed subject matter, especially any reference that may have a publication date after the priority date of this application. The disclosures of all patents, patent applications, and publications cited herein are hereby incorporated by reference, to the extent that they provide exemplary, procedural or other details supplementary to those set forth herein.

1. A method of treating a reservoir fluid mixture comprising an oleaginous component and an aqueous component, the method comprising:
contacting the reservoir fluid mixture with an interface destabilizing composition, wherein the interface destabilizing composition comprises a biochelant and a solvent.

2. The method of claim 1, wherein the biochelant comprises uronic acid, aldaric acid, a salt thereof, a derivative thereof, or a combination thereof.

3. The method of claim 1, wherein the biochelant comprises sodium gluconate, a glucarate, an oxidation product of sodium glucarate, gluconate, a derivative thereof, or a combination thereof.

4. The method of claim 1, wherein the biochelant comprises a buffered glucose oxidation product, a buffered gluconic acid oxidation product, or a combination thereof.

5. The method of claim 4, wherein the buffered glucose oxidation product, the buffered gluconic acid oxidation product, or the combination thereof further comprises n-keto-acids, C₂-C₆ diacids, or a combination thereof.

6. The method of claim 1, wherein the biochelant is present in the interface destabilizing composition in an amount of from about 0.01 wt. % to about 100 wt. % based on the total weight of the interface destabilizing composition.

7. The method of claim 1, wherein the solvent comprises an aqueous fluid, an aromatic hydrocarbon, or both.

8. The method of claim 7, wherein the solvent comprises an alcohol.

9. The method of claim 8, wherein the alcohol comprises methanol, ethanol, isopropanol, ethylene glycol, propylene glycol, or a combination thereof.

10. The method of claim 1, wherein the reservoir fluid comprises a liquid hydrocarbon, an aqueous fluid, an aqueous solution with a dissolved salt, a hydrocarbon gas, a non-hydrocarbon gas, or a combination thereof.

11. The method of claim 1, wherein the interface destabilizing composition comprises an additive selected from the group consisting of a strength-stabilizing agent, a friction reducer, an expansion agent, a salt, a fluid loss agent, a vitrified shale, a thixotropic agent, a dispersing agent, a surfactant, a scale inhibitor, a clay stabilizer, a silicate-control agent, a biocide, a biostatic agent, a storage stabilizer, a filtration control additive, an acid, a base, mutual solvents, an accelerant, a corrosion inhibitor, a defoamer oxidation inhibitor, a thinner, a scavenger, a gas scavenger, or a combination thereof.

12. The method of claim 1, further comprising recovering the oleaginous component of the reservoir fluid mixture.

13. The method of claim 12, wherein the recovery is equal to or greater than about 80%.

14. The method of claim 1, wherein a precipitant formed is reduced by from about 0.2% to less than about 5% when compared to a separation process lacking an interface destabilizing composition.

15. The method of claim 1, wherein the interface destabilizing composition excludes a surfactant.

16. The method of claim 1, wherein the interface destabilizing composition excludes a demulsifier.

17. The method of claim 1, wherein the reservoir fluid mixture comprises an oil-in-water emulsion.

18. The method of claim 1, wherein the interface destabilizing composition is introduced to a separator containing at least a portion of the reservoir fluid.

19. The method of claim 1, wherein the interface destabilizing composition is introduced into a conduit conveying the reservoir fluid from a production well to a separator.

20. The method of claim 1, wherein the interface destabilizing composition is introduced into a gun barrel or wash tank separator.

21. A method of servicing a wellbore, the method comprising:
flowing a reservoir fluid to a vessel, wherein the reservoir fluid comprises an oleaginous component and an aqueous component;
introducing into the vessel an interface destabilizing composition comprising a biochelant and a solvent, wherein the vessel comprises a gun barrel or wash tank separator; and
recovering at least a portion of the oleaginous component from the vessel.
